(19) United States
(12) Patent Application Publication
(10) Pub. No.: US 2008/0113705 A1
(43) Pub. Date: May 15, 2008

(54) VIDEO POKER GAME IN WHICH SOME STARTING HANDS ARE SAVED FOR REUSE AT A LATER TIME

(76) Inventors: ERNEST W. MOODY, LAS VEGAS, NV (US); Michael Fields, Henderson, NV (US)

Correspondence Address: JOHN EDWARD ROETHEL, 769 Basque Way, Suite 200, Carson City, NV, 89706, US

(21) Appl. No.: 11/938,282

(22) Filed: Nov. 11, 2007

Related U.S. Application Data
(60) Provisional application No. 60/858,764, filed on Nov. 14, 2006.

(51) Int. Cl. A63F 13/00; A63F 1/00

(52) U.S. Cl. 463/13; 273/292

(57) ABSTRACT

The method of play of the present invention defines certain initial starting hands as hands that may be replayed by a player at a later point in time if the initial starting hand results in a losing final hand after the draw step has taken place. Any initial starting hand that qualifies for later replay can be stored in the memory of the gaming machine. At a later time, the initial starting hand is displayed to the player for replay. The player may or may not be required to make a wager to replay the initial starting hand.

### CROSS-REFERENCE TO RELATED APPLICATION

The application is based on and claims the benefit of U.S. Provisional Application Ser. No. 60/858,764, filed Nov. 14, 2006, which is incorporated herein by this reference in its entirety.

This invention relates to video poker games, and more particularly to a video poker game in which some of the starting hands are saved for reuse at a later time.

### BACKGROUND OF THE INVENTION

The basic game of video poker involves a game of five card draw. Using a single deck of cards, the player is dealt an initial five card hand. The player selects which of the initial five cards the player wishes to hold and the unheld cards are then discarded. Using the same starting deck of cards, replacement cards are dealt for the cards that were discarded. These five cards comprise the player's final five card hand and this final hand is analyzed based on poker hand ranking. If the player has achieved at least a pair of Jacks or better, the player wins with the amount of the player's winnings determined based on the type of poker hand achieved and the amount of the player's wager.

Video draw poker is generally played on an electronic video gaming machine that uses a video screen display to show the cards to the player. Computer controls carried on a printed circuit board mounted on the interior of the gaming machine electronically shuffle the deck of cards, activate the dealing sequence in response to input by a player, cause the initial five cards to be displayed on the video screen display, deal replacement cards after the player has selected which cards to hold and discard and analyze the final five card hand to determine winning and losing hands. The computer controls also effect payouts to the player based on the amount of the player's wager and the poker hand ranking of the final five card hand.

In order to comply with the regulations of the various gaming jurisdictions in which the video poker games are available to be played, the computer controls also contain sufficient computer memory to store a plurality of previously played games. This allows the casino personnel as well as the jurisdiction's gaming compliance officials to look back at a number of previously played hands of video poker in case a dispute arises regarding a payout or a possible game malfunction.

The electronic video poker gaming machine is designed to replicate the play of a hand of poker. Typically, the player is not playing against any other players or against a dealer's hand; the player is simply attempting to achieve the highest ranking poker hand possible from the cards displayed to the player. The higher the poker hand achieved by the player, the greater the player's winnings based on the number of coins, tokens or credits wagered by the player. Typically, a payout schedule is posted on the gaming machine to advise the player of the payoffs available for certain winning card combinations.

The original classic draw poker machines were then modified to use jokers as wild cards or to use deuces (or even other cards) as wild cards. “Joker's Wild” and “Deuces Wild” draw poker still display to the player a single five card hand and allow the player to discard unwanted cards and receive replacement cards. The payout table is modified to recognize the differing odds for achieving various poker hands when wild cards are involved.

During the play of a hand of video poker, the player often is dealt an initial starting hand that has the possibility of improving into a high payout hand. For example, the player may receive as his initial starting hand four cards to a Royal Flush or a Straight Flush, three cards to a Royal Flush or a Straight Flush or even Three-of-a-Kind. With this initial starting hand, the player may only need to draw one or two cards to complete his hand into a final hand with a very high payout such as a Royal Flush, a Straight Flush or a Four-of-a-Kind. These are very good starting hands for the player to be dealt in that the expected value of these starting hands is quite good. When the player receives these types of starting hands, the player has a good opportunity to receive a nice payout on the final hand after the draw step is completed.

The use of expected value to quantify the relative value of starting hands is well-known and accepted in the video poker business. The expected value of a starting hand is based on the initial five cards received by the player, the pay table being used and the probability of improving the starting hand into a winning combination shown in the pay table. A suitable way of determining the expected value of any starting hand is disclosed in U.S. Pat. No. 6,343,989 (Wood et al.), the disclosure of which is incorporated herein in its entirety.

It has been proposed to offer the player an opportunity to play good starting hands more often than is realized by the basic probability of video draw poker. U.S. Pat. No. 6,045,129 (Cooper et al.) discloses a method of playing video poker in which the player is offered the opportunity to replay the starting hand one time if the player is willing to make an additional wager. This offer is made after the completion of play of the initial hand. Various versions of the method of play disclosed in this Cooper patent offer the opportunity to replay the initial starting hand either a) when the first final hand is a winning hand, b) when the first final hand is a losing hand, or c) on a randomly selected basis regardless of whether the first final hand is a winning hand or losing hand.

### SUMMARY OF THE INVENTION

The method of play of the present invention defines certain initial starting hands as hands that may be replayed by a player at a later point in time if the initial starting hand results in a losing final hand after the draw step has taken place. Any initial starting hand that qualifies for later replay can be stored in the memory of the gaming machine. At a later time, the initial starting hand is displayed to the player for replay. The player may or may not be required to make a wager to replay the initial starting hand.

### BRIEF DESCRIPTION OF THE DRAWINGS

FIG. 1 shows a flow chart of the method of the present invention.

### DETAILED DESCRIPTION OF THE PREFERRED EMBODIMENTS

The method of play of the present invention relates to video poker games in which the player receives an initial starting hand, select the cards the player wishes to discard and then receives replacement cards for the discarded cards. Based on the poker hand ranking of the final five card hand, the player either wins or loses. If the player has a winning final hand, the award to the player is based on the poker hand ranking of the final hand and a pay table associated with the poker game format that is being played. If the player is playing a monetary wagering version of the game, the payout to the player has monetary value. If the player is playing an amusement (non-monetary) version of the game, the player can be awarded points or a similar non-monetary scoring equivalent.

The method of the present invention provides the player with the opportunity to replay certain pre-designated initial starting hands at a later time.

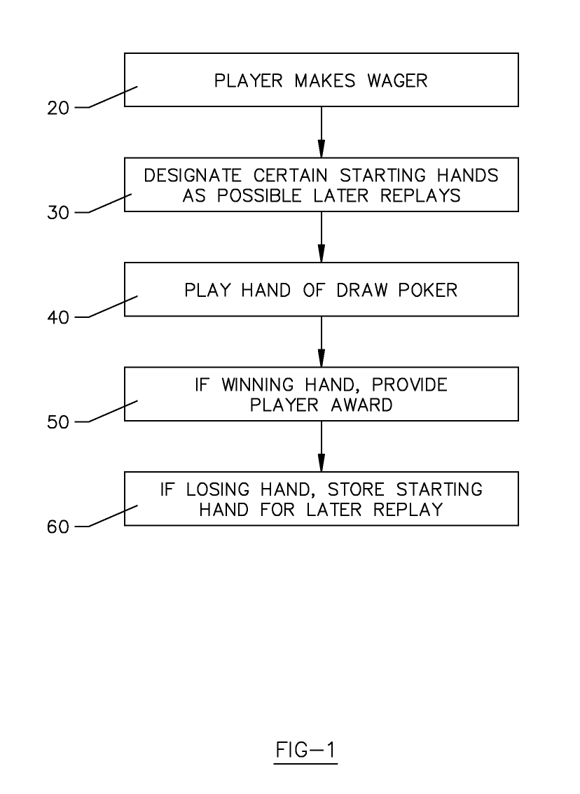

In a preferred embodiment of the present invention, the player starts the play of the game. As shown in FIG. 1, the player would typically make a wager 20 to start the game play.

In a preferred embodiment of the present invention, certain starting hands 30 are pre-designated as possible replay starting hands. For example, if the pay table is a traditional Jacks or Better Draw Poker format pay table, the player may receive as his initial starting hand a display of five cards that includes four cards to a Royal Flush or four cards a Straight Flush, three cards to a Royal Flush or three cards to a Straight Flush or Three-of-a-Kind.

If the starting hand comprises a designated hand that is possible for replay, that is noted by the computer controls of the gaming machine and could be so displayed to the player. The player then plays out the starting hand 40 according to typical draw poker game play.

The player completes the play of this initial starting hand by designating the cards he wishes to hold. The unheld cards are discarded and replacement cards are displayed for the discarded cards resulting in a final hand. The poker hand ranking of the final hand is determined and compared to the winning hand combinations in a pay table. If the player has a winning hand combination, the player receives an award 50.

In a preferred embodiment of the present invention, in order to qualify for a later replay, the player must also have a losing final hand 60 when the initial starting hand is originally played out through the draw step of the video poker game. When the player achieves a losing final hand, the computer controls of the gaming machine store this information for later use. Alternatively, for some starting hands such as Three-of-a-Kind that are designated as eligible for later replay, the player is considered as having a losing hand if the Three-of-a-Kind does not improve into a Full House or a Four-of-a-Kind.

If the player achieves a winning hand combination for the final hand during the original play of the initial starting hand (or improves his hand such as having a Three-of-a-Kind improve into a Full House or a Four-of-a-Kind), the player does not qualify for a replay of the initial starting hand.

If the player has made a monetary wager to play the game, the award has a monetary value. If the player is playing the game as an amusement (non-monetary) game, the award has a non-monetary value and can be points or another scoring equivalent.

If the final hand is a losing hand (or does not improve to a Full House or a Four-of-a-Kind after starting with Three-of-a-Kind), then the initial starting hand is stored in the memory of the gaming machine so that the player has the opportunity to replay this initial starting hand at a later point in time.

Various implementations can be used to determine when the player will have the opportunity to replay the stored starting hand. For example, the player would be given the opportunity to replay a stored starting hand on his next visit to the gaming establishment at which he played the video poker game when he earned the stored starting hand. Or the player may have to wait until a pre-established amount of time had gone by at which point the gaming machine would offer the player the opportunity to replay his stored starting hand. Other implementations could use a prescribed number of game plays or a prescribed amount of wagers being made before the stored starting hand is offered to the player.

More than one stored starting hand can be maintained in the memory of the gaming machine. When that occurs and the player becomes eligible to replay the starting hands, the stored starting hands may be offered to the player either consecutively one at a time or sequentially over a period of time or over a period of game plays or over a period of wager amounts.

For example, the computer controls of the gaming machine can register the number of times during a particular gaming session that the player achieved one or more of the pre-designated starting hands. If the player fails to convert a pre-designated starting hand into a winning hand (or if the player fails to improve a Three-of-a-Kind into a Full House or a Four-of-a-Kind) over the course of a predetermined number of opportunities, say three or five, then the player earns the opportunity to replay the pre-designated starting hand.

One variation of this boomerang implementation is that the opportunity to replay the pre-designated starting hand may be good for a designated length of time, say a number of hours or a number of days. This would encourage the player to continue playing the gaming machine or to return to the casino during the eligibility period to take advantage of this replay opportunity.

The method of the present invention can be applied to any of the myriad of poker formats used in video draw poker. These poker game formats include Jacks (or even Tens) or Better Draw Poker, Bonus Poker, Double Bonus Poker, Double Double Bonus Poker, Super Double Bonus Poker, Triple Bonus Poker, Deuces Wild Poker, Jokers Wild Poker, Deuces and Jokers Wild Poker, etc. Each poker format has its own pay table associated therewith.

Each poker format would have its own pre-designated starting hands that could qualify the player for a replay of the starting hand.

Alternatively, the starting hands that could qualify the player for a replay of the starting hand could be designated by determining the expected value of the starting hand. As mentioned above, the use of expected value to quantify the relative value of any starting hand is well-known and accepted in the video poker business. The expected value of a starting hand is based on the initial five cards received by the player, the pay table being used and the probability of improving the starting hand into a winning combination shown in the pay table. A suitable way of determining the expected value of any starting hand is disclosed in U.S. Pat. No. 6,343,989 (Wood et al.), the disclosure of which is incorporated herein in its entirety.

In accordance with the present invention, a threshold level of expected value for a starting hand that could qualify the player for a replay of the starting hand could be established. Then any starting hand that meets or exceeds this threshold level of expected value would then qualify as a possible replay starting hand. For example, any starting hand that has an expected value of 4.0 or higher for each unit wagered would then qualify as a possible replay starting hand.

In accordance with the present invention, the player may or may not be required to make a wager to replay the stored starting hand.

While the invention has been illustrated with respect to several specific embodiments thereof, these embodiments should be considered as illustrative rather than limiting. Various modifications and additions may be made and will be apparent to those skilled in the art.

What is claimed is:

1. A method of playing a poker game comprising:
a) designate certain starting hands as hands that are eligible to be replayed at a later time;
b) display a starting hand to a player;
c) allow the player to select cards to be discarded;
d) discard the selected cards and display replacement cards therefore to establish a final hand;
e) determine whether the final hand is a winning hand or a losing hand;
f) if the final hand is a losing hand, store the starting hand for later replay; and
g) if the final hand is a winning hand, provide the player with an award.
